(19) United States
(12) Patent Application Publication
(10) Pub. No.: US 2026/0281225 A1
(43) Pub. Date: Sep. 17, 2026

(54) ADAPTER FOR SMARTPHONE DOCK

(71) Applicant: Lenovo (United States) Inc., Morrisville, NC (US)

(72) Inventors: Bryan Binda, Cary, NC (US); Pacheng Ly, Fuquay Varina, NC (US); Chunjian Ni, Cary, NC (US)

(21) Appl. No.: 19/077,997

(22) Filed: Mar. 12, 2025

(51) Int. Cl. H04M 1/04; G06F 3/02; H04M 1/02

(52) U.S. Cl. CPC H04M 1/04; G06F 3/0224; H04M 1/0274

(57) ABSTRACT

A smartphone dock includes a chassis having a keyboard and display. A hinge has a leaf coupled to the chassis and a leg rotatable about a first end of the leaf located further from the dipaly than a second end of the leaf. A tray is releasably coupled to the leg. The tray includes keying structures coupled to a top surface of the tray to guide a smartphone into the tray. The keying structures facilitate connecting the smartphone with an electrical connector within a first end of the tray to electrically connect the smartphone to the chassis.

### BACKGROUND

A smartphone dock is device that includes a physical keyboard, such as a keyboard (e.g., a QWERTY keyboard) and a display in a clam shell type arrangement. A smartphone is coupled to the smartphone dock and accepts data entry from the keyboard and also provides display output to the display of the smartphone dock. In prior smartphone docks, the phone may lie flat on a chassis of the physical keyboard the smartphone dock, making the display of the smartphone inconvenient for viewing. Other prior smartphone docks may accommodate one size of smartphone.

### SUMMARY

A smartphone dock includes a chassis having a keyboard and display. A hinge has a leaf coupled to the chassis and a leg rotatable about a first end of the leaf located further from the display than a second end of the leaf. A tray is releasably coupled to the leg. The tray includes keying structures coupled to a top surface of the tray to guide a smartphone into the tray. The keying structures facilitate connecting the smartphone with an electrical connector within a first end of the tray to electrically connect the smartphone to the chassis.

### BRIEF DESCRIPTION OF THE DRAWINGS

FIG. 1 is a perspective view of a smartphone dock having a tiltable adapter for a smartphone according to an example embodiment.

FIG. 2 is a perspective view of the smartphone dock with a smartphone coupled within the adapter according to an example embodiment.

FIG. 3 is a perspective view of an example hinge for an adapter according to an example embodiment.

FIG. 4 is a block perspective view of an adapter illustrating coupling of legs of a hinge to a tray according to an example embodiment.

FIG. 5 is a side view of an adapter illustrating coupling of legs of a hinge to a tray according to an example embodiment.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

In prior smartphone docks, the phone may lie flat on a chassis of the physical keyboard the smartphone dock, making the display of the smartphone inconvenient for viewing. The phone may not be mechanically secured in place. Other prior smartphone docks may accommodate one size of smartphone.

An improved tiltable adapter connects a smartphone to a smartphone dock allows connection of the smartphone to the smartphone dock for using a keyboard and display of the smartphone dock to interact with the smartphone while enabling adjustment of a user viewing angle of the connected smartphone.

In one example, the adapter includes keying mechanical features to help guide the smartphone into the adapter to create an electrical connection with the smartphone dock. The keyed features allow for blind-mating of the smartphone without the need for a user to adjust the position of the smartphone to ensure connection is made.

A hinge is used to couple the adapter to the smartphone dock. In one example, the adapter is releasably coupled to the hinge, allowing different adapters to be substituted for different size smartphones. The hinge may provide sufficient rotational resistance via a friction fit to enable adjustment of a viewing angle of the phone while securing the phone at a desired viewing angle and maintaining that angle once adjusted.

The electrical connection in one example is a Universal Serial Bus (USB) connector, such as a USB Type C (USB-C) connector, although the present disclosure is not limited thereto. In some embodiments, other adapters may provide different connectors for different types and sizes of smartphones.

In one example, the dock includes a recess to fit the adapter to allow the display to lay flat on the keyboard in a closed position. The recess may be deep enough to also fit the smartphone when the keyboard is in the closed position.

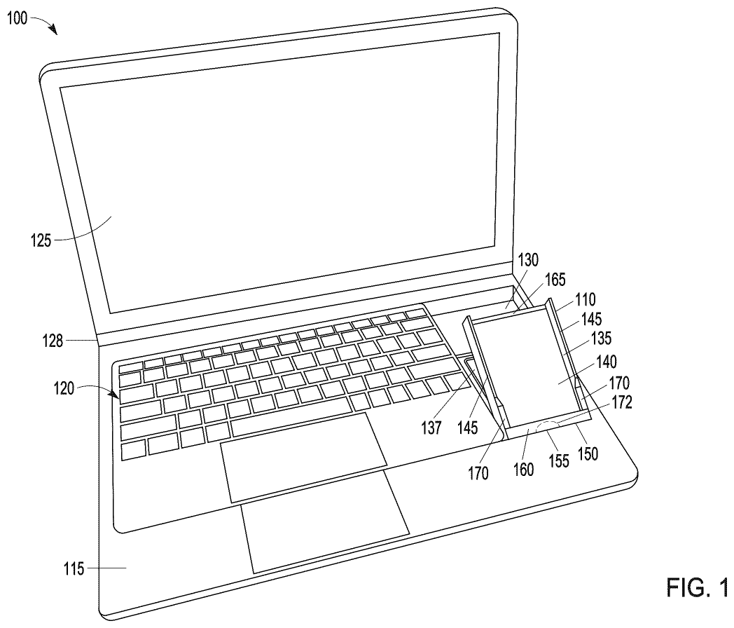

FIG. 1 is a perspective view of a smartphone dock 100 having a tiltable adapter 110 for a smartphone. The smartphone dock 100 includes a chassis 115 that includes a keyboard 120 coupled to a display 125. The dock 100 may be docking station for a smartphone or other electronic device or may be a laptop computer or other electronic device configured to support a smartphone in further examples.

The keyboard 120 and display 125 may be coupled via a display hinge 128 to form a clamshell like structure that can be opened in different desired positions (shown at an angle of about 90 or so degrees from a top surface of the chassis 115) and closed as desired. Chassis 115 may include recess 130 for supporting the tiltable adapter 110 at least partially disposed within the recess 130. The recess 130 may be sized to fit a desired range of sizes of smartphones or one particular size.

The tiltable adapter 110 includes a tray 135 that may be releasably coupled to an adapter hinge 137 (partially visible) that is coupled to the chassis of the smartphone dock 100 such as within the recess 130. In one example, a rotatable portion of the adapter hinge 137 is located toward or at a first end of the recess 130 that nearest a user of the smartphone dock 100. The recess may be located to one side of the keyboard 120 or in any other desired location of the smartphone dock 100.

Tray 135 includes a first surface 140 sized to fit a footprint of a rear surface or back side of aselected smartphone. Sidewalls 145 extend up from the first surface 140 to about the depth of the selected smartphone. A first end 150 of the tray is positioned at an end of a rotating portion of the hinge and remains next to the chassis 115 in response to rotation of the hinge. The first end 150 of the tray 135 includes a first end wall 155 with a top or roof portion 160 that extends back toward the other end, a second end 165 of the tray 135 and acts as a guide to provide a smartphone keying structure.

The smartphone keying structure also includes top or roof portions 170 of the sidewalls 145 that extend a desired distance back toward the other end of the tray. The sidewalls 145 and top or roof portions 170 help guide the smartphone into a desired position within the tray 135 and cause mating of a connector on the smartphone to a mating connector 172 (shown in broken line form as a USB-C plug) in the first end 150 of the tray that is electrically coupled to the smartphone dock for interfacing with the keyboard 120 and display 125. The mating connectors, such as USB-C plug and port connectors, may also be used to recharge the smartphone via charging circuitry within the smartphone dock 100.

Further aspects of the smartphone keying structure may include a slight angling out of the sidewalls 145 from the first end 150 of the tray 135. Such angling out may make it easier to start to insert the smartphone into the tray, as the distance between the sidewalls is slightly longer near the second end 165 of the tray 135. The sidewalls 145 may also be lower at the second end 165 and gradually, or in different steps rise to at least the depth of the smartphone. Note that the tray size may be varied for use with different size smartphones and those with or without protective cases.

In some embodiments, a processor or other electronic components that are not shown in FIG. 1 may be present with in the chassis 115 and may facilitate communication and/or data transfer. In some embodiments, the smartphone dock 100 may have components and corresponding functionality to implement a computing device (e.g., a laptop or netbook computing device).

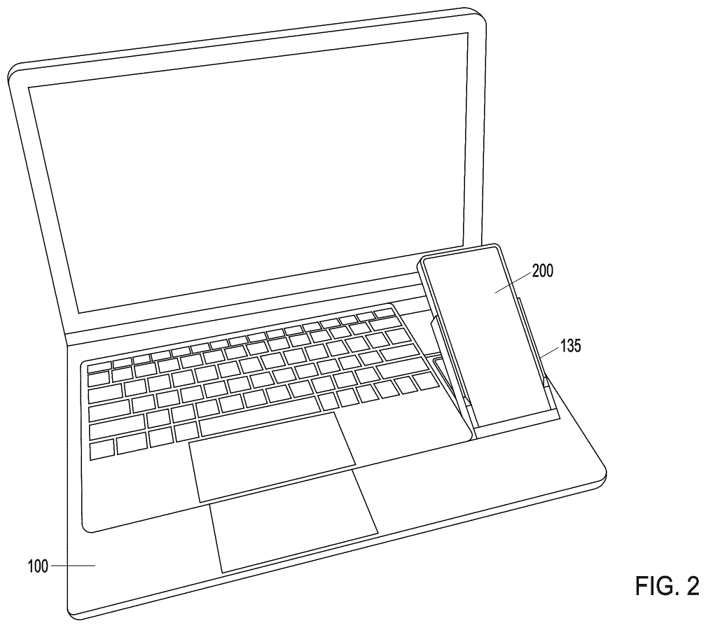

FIG. 2 is a perspective view of the smartphone dock 100 with a smartphone 200 coupled within the tray 135. Tray 135 may be formed of a rigid material such as plastic by injection molding or printed in various examples. The smartphone 200 is shown fully inserted into the tray 135 and is electrically connected to the smartphone dock 100 having been guided into place to connect with a connector in the tray 135.

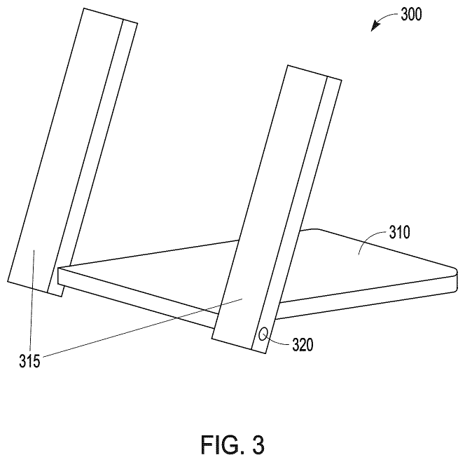

FIG. 3 is a perspective view of an example hinge 300 for an adapter. The hinge 300 includes a flat leaf or base 310 with two hinged legs 315 rotatable from a flat position parallel to the flat base to an angled position about a hinge coupling 320. The base 310 may be secured within the recess by adhesive, solder, screws, or other fasters. The hinge coupling 320 may include one or more hinge pin openings or barrels with a hinge pin inserted through the openings. The hinge coupling provides sufficient friction or resistance to rotations to require greater force than the weight of a phone to move the legs 315 to different positions. In one example, the hinge 300 may be formed from a Hagibis brand Cell Phone Stand for Desk, Foldable Aluminum Phone Holder by removing portions of the legs of the phone holder that operate to elevate the phone, leaving a hinge 300 that fits within the recess 130.

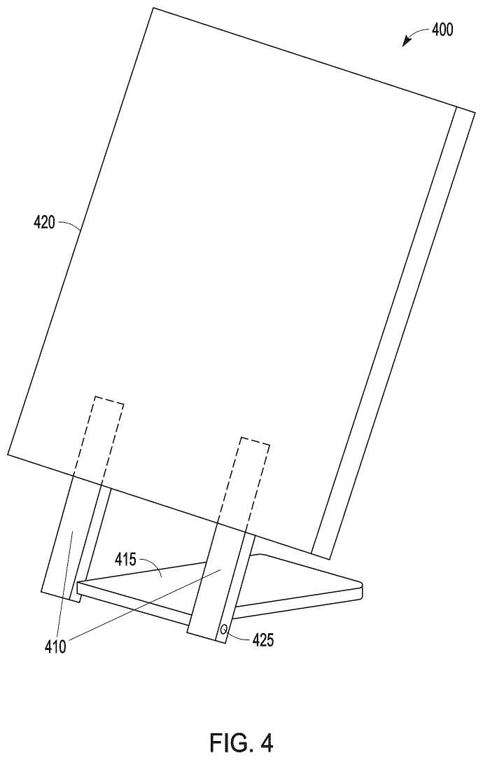

FIG. 4 is a block perspective view of an adapter 400 illustrating coupling of legs 410 of a hinge 415 to a tray 420. While two legs 410 are shown, one or more than two legs may be used in further examples. In one example, the legs 410 may simply be a single second leaf of the hinge 415. The tray may include slots or holes (not shown) for mating with the legs 410. The slots may be formed within the tray 420 or as an added clip-like structure either coupled to a backside of the tray or injection molded with the tray 420. Tray 420 is shown partially attached to the legs 420 with portions of the legs 410 behind the tray 420 shown in broken line form. The tray 420 may be fully attached when moved proximate to a hinge coupling 425.

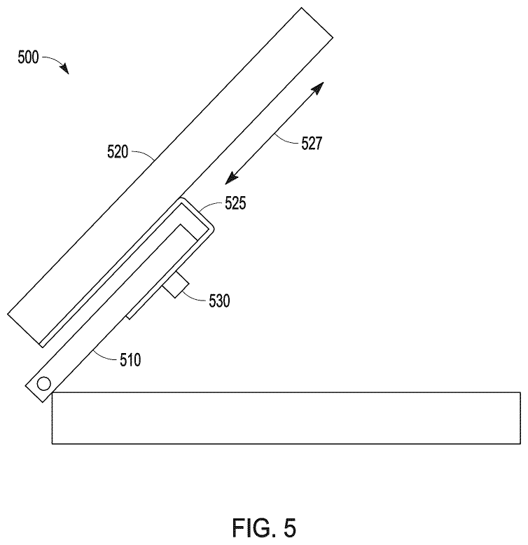

FIG. 5 is a side view of an adapter 500 illustrating coupling of legs 510 of a hinge 515 to a tray 520. Adapter 500 includes a clip or slot 525 for mating with the legs 510 as illustrated by arrow 527 and may include a latch and button combination 530 for releasably locking the legs 510 and hence tray 520 to the slot 525. Releasably locking the tray 520 enables easy replacement of the tray 520 with trays configured to fit different size smartphones, allowing the hinge 515 to remain in place.

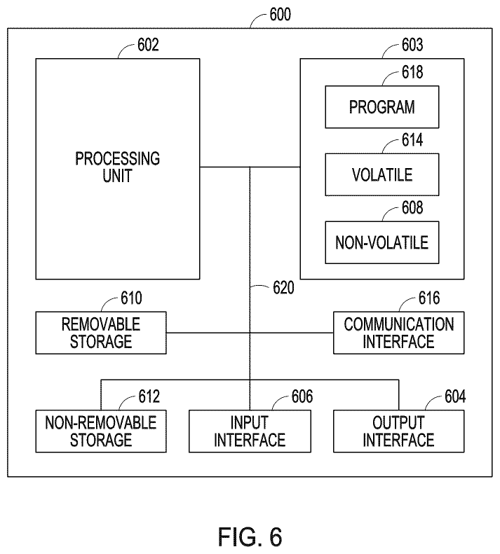

FIG. 6 is a block schematic diagram of a computer system 600 to implement one or more of a docking station, laptop, or smartphone and for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include- or have access to a computing environment that includes-a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 618 may be used to cause processing unit 602 to perform one or more methods or algorithms described herein.

### EXAMPLES

1. A smartphone dock includes a chassis having a keyboard and display. A hinge has a leaf coupled to the chassis and a leg rotatable about a first end of the leaf located further from the display than a second end of the leaf. A tray is releasably coupled to the leg. The tray includes keying structures coupled to a top surface of the tray to guide a smartphone into the tray. The keying structures facilitate connecting the smartphone with an electrical connector within a first end of the tray to electrically connect the smartphone to the chassis.

2. A smartphone dock includes a chassis having a keyboard and display, a hinge having a leaf coupled to the chassis and a leg rotatable about a first end of the leaf located closer to a user of the smartphone dock than a second end of the leaf, and a tray releasably coupled to the leg, the tray including keying structures coupled to a top surface of the tray to guide a smartphone into the tray.

3. The smartphone dock of example 2 wherein the keying structures guide the smartphone to connect with an electrical connector within a first end of the tray commensurate with the first end of the leaf to electrically connect the smartphone to the chassis.

4. The smartphone dock of any of examples 2-3 wherein the chassis includes a recess and wherein the leaf is coupled to the chassis within the recess.

5. The smartphone dock of any of examples 2-4 wherein the leg comprises two spaced apart legs and wherein the tray includes two slots configured to releasably retain the legs.

6. The smartphone dock of example 5 wherein the slots comprise clips attached to a backside of the tray.

7. The smartphone dock of example 5 wherein the slots include at least one latch and button combination for releasably locking the tray to the slots.

8. The smartphone dock of any of examples 3-7 wherein the keying structures of the tray comprise sidewalls extending upward from a top surface of the tray.

9. The smartphone dock of example 8 wherein the keying structures of the tray include a first end wall with a roof portion extending away from the first end toward a second end of the leaf.

10. The smartphone dock of example 9 wherein the electrical connector is between the sidewalls and under the roof portion of the end wall.

11. The smartphone dock of example 10 wherein the sidewalls include roof portions partially extending over the leaf portion to vertically position the smartphone within top surface of the tray and within the keying structures to mate a smartphone connector with the electrical connector.

12. The smartphone dock of any of examples 8-11 wherein the sidewalls are angled outward from the first end of the tray toward a second end of the tray.

13. A smartphone holder for a smartphone dock, the smartphone holder includes a hinge having a leaf for coupling to a chassis of the smartphone dock and a leg rotatable about a first end of the leaf and a tray releasable coupled to the leg, the tray including keying structures coupled to a top surface of the tray to guide a smartphone to connect with an electrical connector within a first end of the tray commensurate with the first end of the leaf to electrically connect the smartphone to the chassis.

14. The smartphone holder of example 13 wherein the leg comprises two spaced apart legs and wherein the tray includes two slots configured to releasably retain the legs.

15. The smartphone holder of example 14 wherein the slots comprise clips attached to a backside of the tray.

16. The smartphone holder of any of examples 14-15 wherein the slots include at least one latch and button combination for releasably locking the tray to the slots.

17. The smartphone holder of any of examples 13-16 wherein the keying structures of the tray comprise sidewalls extending upward from a top surface of the tray.

18. The smartphone holder of example 17 wherein the keying structures of the tray include a first end wall with a roof portion extending away from the first end toward a second end of the leaf.

19. The smartphone holder of example 18 wherein the electrical connector is between the sidewalls and under the roof portion of the end wall and wherein the electrical connector comprises a USB-C connector and wherein the hinge is configured to enable tilting of the smartphone to change a viewing angle of the smartphone.

20. The smartphone holder of example 19 wherein the sidewalls include roof portions partially extending over the leaf portion to vertically position the smartphone within top surface of the tray and within the keying structures to mate a smartphone connector with the electrical connector.

21. The smartphone holder of any of examples 17-20 wherein the sidewalls are angled outward from the first end of the tray toward a second end of the tray.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A smartphone dock comprising:
a chassis having a keyboard and display;
a hinge having a leaf coupled to the chassis and a leg rotatable about a first end of the leaf located further from the display than a second end of the leaf; and
a tray releasably coupled to the leg, the tray including keying structures coupled to a top surface of the tray to guide a smartphone into the tray.

2. The smartphone dock of claim 1 wherein the keying structures guide the smartphone to connect with an electrical connector within a first end of the tray commensurate with the first end of the leaf to electrically connect the smartphone to the chassis.

3. The smartphone dock of claim 1 wherein the chassis includes a recess and wherein the leaf is coupled to the chassis within the recess.

4. The smartphone dock of claim 1 wherein the leg comprises two spaced apart legs and wherein the tray includes two slots configured to releasably retain the legs.

5. The smartphone dock of claim 4 wherein the slots comprise clips attached to a backside of the tray.

6. The smartphone dock of claim 4 wherein the slots include at least one latch and button combination for releasably locking the tray to the slots.

7. The smartphone dock of claim 2 wherein the keying structures of the tray comprise sidewalls extending upward from a top surface of the tray.

8. The smartphone dock of claim 7 wherein the keying structures of the tray include a first end wall with a roof portion extending away from the first end toward a second end of the leaf.

9. The smartphone dock of claim 8 wherein the electrical connector is between the sidewalls and under the roof portion of the end wall.

10. The smartphone dock of claim 9 wherein the sidewalls include roof portions partially extending over the leaf portion to vertically position the smartphone within top surface of the tray and within the keying structures to mate a smartphone connector with the electrical connector.

11. The smartphone dock of claim 7 wherein the sidewalls are angled outward from the first end of the tray toward a second end of the tray.

12. A smartphone holder for a smartphone dock, the smartphone holder comprising:
a hinge having a leaf for coupling to a chassis of the smartphone dock and a leg rotatable about a first end of the leaf; and
a tray releasable coupled to the leg, the tray including keying structures coupled to a top surface of the tray to guide a smartphone to connect with an electrical connector within a first end of the tray commensurate with the first end of the leaf to electrically connect the smartphone to the chassis.

13. The smartphone holder of claim 12 wherein the leg comprises two spaced apart legs and wherein the tray includes two slots configured to releasably retain the legs.

14. The smartphone holder of claim 13 wherein the slots comprise clips attached to a backside of the tray.

15. The smartphone holder of claim 13 wherein the slots include at least one latch and button combination for releasably locking the tray to the slots.

16. The smartphone holder of claim 12 wherein the keying structures of the tray comprise sidewalls extending upward from a top surface of the tray.

17. The smartphone holder of claim 16 wherein the keying structures of the tray include a first end wall with a roof portion extending away from the first end toward a second end of the leaf.

18. The smartphone holder of claim 17 wherein the electrical connector is between the sidewalls and under the roof portion of the end wall and wherein the electrical connector comprises a USB-C connector and wherein the hinge is configured to enable tilting of the smartphone to change a viewing angle of the smartphone.

19. The smartphone holder of claim 18 wherein the sidewalls include roof portions partially extending over the leaf portion to vertically position the smartphone within top surface of the tray and within the keying structures to mate a smartphone connector with the electrical connector.

20. The smartphone holder of claim 16 wherein the sidewalls are angled outward from the first end of the tray toward a second end of the tray.
